(19) United States
(12) Patent Application Publication
(10) Pub. No.: US 2024/0339731 A1
(43) Pub. Date: Oct. 10, 2024

(54) SEPARATOR, ELECTROCHEMICAL DEVICE CONTAINING SAME, AND ELECTRONIC DEVICE

(71) Applicant: Ningde Amperex Technology Limited, Ningde (CN)

(72) Inventors: Mingchang ZHU, Ningde (CN); Dongyang GUO, Ningde (CN); Qingwen ZHANG, Ningde (CN); Minjing CHEN, Ningde (CN)

(73) Assignee: Ningde Amperex Technology Limited, Ningde (CN)

(21) Appl. No.: 18/622,071

(22) Filed: Mar. 29, 2024

(30) Foreign Application Priority Data
Apr. 6, 2023 (CN) 202310356424.0

(51) Int. Cl. H01M 50/491; H01M 50/417; H01M 50/44; H01M 50/454

(52) U.S. Cl. CPC H01M 50/491; H01M 50/417; H01M 50/44; H01M 50/454

(57) ABSTRACT

A separator includes a porous substrate and an inorganic coating layer disposed on at least one surface of the porous substrate. The porous substrate includes fibers. The fibers are made of a material including at least one of polyethylene or polypropylene. A diameter of the fibers is 0.01 μm to 0.70 μm. A diameter difference between any two fibers ranges from 0 μm to 0.40 μm. The inorganic coating layer includes a polymer and inorganic particles. The polymer includes at least one of styrene-butadiene rubber, a polyacrylate ester, or a polyolefin. The polymer can be modified by a functional group. The modifying functional group includes at least one of —OH, —COOH, or —NH. The above settings improve the infiltration effect of the electrolyte solution for the separator and the capability of the separator in retaining the electrolyte solution, thereby improving the cycle performance of the electrochemical device.

### CROSS REFERENCE TO RELATED APPLICATIONS

This application claims priority to the Chinese Patent Application Ser. No. 202310356424.0, filed on Apr. 6, 2023, the content of which is incorporated herein by reference in its entirety.

### TECHNICAL FIELD

This application relates to the field of electrochemical technology, and in particular, to a separator, an electrochemical device containing the separator, and an electronic device.

### BACKGROUND

Lithium-ion batteries are characterized by a high open-circuit voltage, a high energy storage density, a low self-discharge rate, environmental friendliness, safety, and the like. With the lithium-ion batteries being used more widely in electronic products such as mobile phones, laptop computers, unmanned aerial vehicles, electric motorcycles, and electric vehicles, it is more urgent to further improve performances of the lithium-ion batteries. Further improvement of the cycle performance has always been one of the technical challenges of the lithium-ion batteries. Therefore, it is an urgent need to enhance the cycle performance of the lithium-ion batteries.

### SUMMARY

An objective of this application is to provide a separator, an electrochemical device containing the separator, and an electronic device to improve cycle performance of the electrochemical device. Specific technical solutions are as follows:

A first aspect of this application provides a separator. The separator includes a porous substrate and an inorganic coating layer disposed on at least one surface of the porous substrate. The porous substrate includes fibers. The fibers are made of a material including at least one of polyethylene or polypropylene. A diameter of the fibers is 0.01 μm to 0.70 μm, and preferably 0.01 μm to 0.40 μm. A diameter difference between any two fibers ranges from 0 μm to 0.40 μm, and preferably 0 μm to 0.25 μm. The inorganic coating layer includes a polymer and inorganic particles. The polymer includes at least one of styrene-butadiene rubber, a polyacrylate ester, or a polyolefin. Alternatively, the polymer includes a modifying functional group. The modifying functional group includes at least one of —OH, —COOH, or —NH. By coating the porous substrate with a ceramic coating layer containing inorganic particles and the polymer, and by controlling the diameter of the fibers and the diameter difference to fall within the ranges specified herein, this application defines the structures of the inorganic particles and the modified polymer. By controlling the diameter of the fibers and the diameter difference in the porous substrate of this application to fall within the ranges specified herein, and by applying the modifying functional group that falls with the range specified herein, this application improves the infiltration effect of the electrolyte solution. The porous substrate and the inorganic coating layer work synergistically to improve the infiltration effect of the electrolyte solution for the separator and the capability of the separator in retaining the electrolyte solution, thereby improving the cycle performance of the battery.

In some embodiments of this application, the inorganic particles contains straight through pores. An average diameter of the straight through pores is 0.01 μm to 0.2 μm, and preferably 0.1 μm to 0.2 μm. By controlling the average diameter of the straight through pores of the inorganic particles in the coating layer to fall within the above range, this application reduces the hindrance caused in the ions transport process, and improves the cycle performance of the battery.

In some embodiments of this application, an infiltrated length of the separator by the electrolyte solution is 30 mm to 82 mm, and preferably 65 mm to 82 mm. By controlling the infiltration length of the separator by the electrolyte solution to fall within the above range, this application makes the separator well infiltrated by the electrolyte solution and improves the capability of the separator in retaining the electrolyte solution, thereby improving the cycle performance of the battery.

In some embodiments of this application, an average diameter of pores in the porous substrate is 0.01 μm to 0.4 μm, and preferably 0.1 μm to 0.4 μm. By controlling the pore diameter of the porous substrate to fall within the above range, this application reduces the hindrance caused in the ion transport process, and improves the cycle performance of the battery.

In some embodiments of this application, a porosity of the porous substrate is 40% to 60%, and preferably 48% to 60%. By controlling the porosity of the porous substrate to fall within the above range, more electrolyte solution can be adsorbed, and in turn, the cycle performance of the battery is improved.

In some embodiments of this application, a thickness of the porous substrate is 5 μm to 40 μm, and preferably 5 μm to 25 μm. By controlling the thickness of the porous substrate to fall within the above range, this application increases the energy density of the battery, thereby increasing the service life of the electronic device.

In some embodiments of this application, a ratio of the thickness of the inorganic coating layer to the thickness of the porous substrate is 1:2 to 1:6. By controlling the ratio of the thickness of the inorganic coating layer to the thickness of the porous substrate to fall within the above range, this application effectively reduces the ionic resistance of the separator and improves the infiltration effect of the electrolyte solution for the separator, thereby improving the cycle performance of the battery.

In some embodiments of this application, a particle size D₅₀ of the inorganic particles is 0.30 μm to 1.80 μm, and preferably 0.5 μm to 0.8 μm. By controlling the particle size D₅₀ of the inorganic particles in the coating layer to fall within the above range, this application improves mechanical strength of the separator, and at the same time, makes the separator more resistant to heat shrinkage, thereby improving the cycle performance of the battery.

In some embodiments of this application, a mass ratio between the inorganic particles and the polymer is 9:1 to 32:1. By controlling the mass ratio between the inorganic particles and the polymer to fall within the above range, this application improves the infiltration effect of the electrolyte solution for the separator, thereby improving the cycle performance of the battery.

In some embodiments of this application, the inorganic particles include at least one of aluminum oxide, boehmite, or magnesium oxide. By using the above types of inorganic particles, this application enables the preparation of a straight through pore structure, improves the mechanical strength of the separator, and at the same time, improves the infiltration effect of the electrolyte solution for the separator, and improves the cycle performance of the battery. In some embodiments of this application, a swelling degree of the polymer is 10% to 200%. By controlling the swelling degree of the polymer to fall within the above range, this application improves the affinity of the electrolyte solution, thereby improving the cycle performance of the battery.

In some embodiments of this application, a particle size D₅₀ of the polymer is 0.15 μm to 0.55 μm. By controlling the particle size D₅₀ of the polymer to fall within the above range, this application increases the adhesion of the polymer to the inorganic particles and the substrate, thereby improving the cycle performance of the battery.

In some embodiments of this application, a glass transition temperature of the polymer is −50° C. to 70° C. By controlling the glass transition temperature of the polymer to fall within the above range, this application increases the adhesion of the polymer to the inorganic particles and the substrate, thereby improving the cycle performance of the battery.

In some embodiments of this application, a specific surface area of the inorganic particles is 15 m²/g to 100 m²/g. By controlling the specific surface area of the inorganic particles to fall within the above range, this application facilitates transport of the electrolyte solution, and improves the infiltration effect of the electrolyte solution for the separator, thereby improving the cycle performance of the battery.

In some embodiments of this application, a porosity of the separator is 30% to 70%. By controlling the porosity of the separator to fall within the above range, this application improves the capability of the separator in retaining the electrolyte solution, and at the same time, reduces a transfer resistance of lithium ions, thereby improving the cycle performance of the battery.

In some embodiments of this application, an air permeability of the separator is 50 s/100 cc to 300 s/100 cc. By controlling the air permeability of the separator to fall within the above range, this application reduces the ionic resistance of the separator and improves the effect of infiltrating the separator, thereby improving the cycle performance of the battery.

In some embodiments of this application, a transverse shrinkage of the separator at 1300 C is MD, satisfying: MD≤10%; and the longitudinal shrinkage of the separator at 130° C. is TD, satisfying: TD≤10%. By controlling the transverse and longitudinal shrinkages of the separator to fall within the above ranges, this application improves the safety performance of the battery, thereby increasing the service life of the electronic device. A second aspect of this application provides an electrochemical device, including a positive electrode plate, a negative electrode plate, a separator, and an electrolyte solution. The separator is located between the positive electrode plate and the negative electrode plate. The separator is the separator disclosed in any one of the foregoing embodiments. Therefore, good cycle performance is exhibited.

In some embodiments of this application, the negative electrode plate includes silicon. The mass percent of silicon is 1% to 30%. The polymer containing at least one of the modifying functional groups —COOH, —NH, or —OH can be grafted onto the surface of the silicon-containing material that satisfies the range of the mass percent of silicon specified herein, thereby further reducing the volume expansion of the silicon-containing negative electrode, and in turn, improving the cycle performance of the electrochemical device.

A third aspect of this application provides an electronic device. The electronic device includes the electrochemical device according to any one of the embodiments described above. Therefore, the electronic device exhibits a relatively long service life.

This application provides a separator, an electrochemical device containing the separator, and the electronic device. The separator includes a porous substrate and an inorganic coating layer disposed on at least one surface of the porous substrate. The porous substrate includes fibers. The fibers are made of a material including at least one of polyethylene or polypropylene. A diameter of the fibers is 0.01 μm to 0.70 μm. A diameter difference between any two fibers ranges from 0 μm to 0.40 μm, thereby reducing the ionic resistance of the separator and improving the capability of the separator in retaining the electrolyte solution. The inorganic coating layer includes a polymer and inorganic particles. The polymer includes at least one of styrene-butadiene rubber, a polyacrylate ester, or a polyolefin. The polymer can be modified by a functional group. The modifying functional group includes at least one of —OH, —COOH, or —NH, thereby improving the affinity of the separator for the electrolyte solution. Therefore, by synergistically controlling the above parameters of the separator to fall within the ranges specified herein, this application improves the cycle performance of the electrochemical device.

Definitely, a single product or method in which the technical solution of this application is implemented does not necessarily achieve all of the above advantages concurrently.

### BRIEF DESCRIPTION OF THE DRAWINGS

To describe the technical solutions in some embodiments of this application more clearly, the following outlines the drawings to be used in the description of the embodiments. Evidently, the drawings outlined below merely illustrate some embodiments of this application, and a person of ordinary skill in the art may derive other embodiments based on the drawings.

FIG. 1 is a scanning electron microscope (SEM) image of a conventional substrate according to Comparative Embodiment 1 of this application; and

FIG. 2 is a scanning electron microscope (SEM) image of a porous substrate according to Embodiment 1-1 of this application.

### DETAILED DESCRIPTION

The following describes the technical solutions in some embodiments of this application clearly in detail with reference to the drawings appended hereto. Evidently, the described embodiments are merely a part of but not all of the embodiments of this application. All other embodiments derived by a person of ordinary skill in the art based on the embodiments of this application fall within the protection scope of this application.

It is hereby noted that in specific embodiments of this application, this application is construed by using a lithium-ion battery as an example of the electrochemical device, but the electrochemical device according to this application is not limited to the lithium-ion battery.

An objective of this application is to provide a separator, an electrochemical device containing the separator, and an electronic device to improve cycle performance of the electrochemical device.

A first aspect of this application provides a separator. The separator includes a porous substrate and an inorganic coating layer disposed on at least one surface of the porous substrate. The porous substrate includes fibers. The fibers are made of a material including at least one of polyethylene or polypropylene. A diameter of the fibers is 0.01 μm to 0.70 μm, and preferably 0.01 μm to 0.40 μm. A diameter difference between any two fibers ranges from 0 μm to 0.40 μm, and preferably 0 μm to 0.25 μm. For example, the diameter of the fibers may be 0.01 μm, 0.05 μm, 0.10 μm, 0.15 μm, 0.20 μm, 0.25 μm, 0.30 μm, 0.35 μm, 0.40 μm, 0.45 μm, 0.50 μm, 0.55 μm, 0.60 μm, 0.65 μm, 0.70 μm, or a value falling within a range formed by any two thereof. The diameter difference between any two fibers may be 0 μm, 0.05 μm, 0.10 μm, 0.15 μm, 0.20 μm, 0.25 μm, 0.30 μm, 0.35 μm, 0.40 μm, or a value falling within a range formed by any two thereof. The diameter difference between the fibers means a difference between a maximum diameter and a minimum diameter of any two fibers. The inorganic coating layer includes a polymer and inorganic particles. The polymer includes at least one of styrene-butadiene rubber, a polyacrylate ester, or a polyolefin. The polymer can be modified by a modifying functional group. The modifying functional group includes at least one of —OH, —COOH, or —NH, for example, styrene-butadiene rubber, polyacrylate ester, polyolefin, styrene-butadiene rubber with —OH, polyacrylate ester with —OH, polyacrylate ester with —COOH and —NH, polypropylene with —COOH, polypropylene with —NH, or the like.

The porous substrate of this application causes a smaller hindrance in the ion transport process, and adsorbs more electrolyte solution, thereby improving the electrolyte retention capability, and in turn, improving the long-term cycle performance of the battery. By using the polymers such as styrene-butadiene rubber or polyacrylate ester as a binder, by means of grafting of a polar functional group (for example, —OH, —COOH, or —NH), this application improves the infiltration effect of the electrolyte solution while implementing the adhesion of the ceramic coating layer to a base film. The inorganic particles (aluminum oxide, boehmite, or the like) form a straight through pore structure, thereby improving the mechanical strength of the separator, and at the same time, improving the infiltration effect of the electrolyte solution for the separator and the capability of the separator in retaining the electrolyte solution.

“The coating layer disposed on at least one surface of the substrate” means that the coating layer is disposed on one surface of the substrate along the thickness direction of the substrate or that the coating layer is disposed on both surfaces of the substrate along the thickness direction.

Overall, the separator according to the first aspect of this application, the porous substrate is used together with the inorganic coating layer disposed on at least one surface of the porous substrate. The diameter of the fibers in the porous substrate and the diameter difference between any two fibers are controlled to fall within the ranges specified herein. The structures of the polymer and the inorganic particles in the inorganic coating layer are required to meet the specified conditions so that the porous substrate and the inorganic coating layer work synergistically, thereby reducing the hindrance in an ion transport process, increasing the mechanical strength of the separator, and at the same time, improving the infiltration effect of the electrolyte solution for the separator and the capability of the separator in retaining the electrolyte retention, and in turn, improving the cycle performance of the battery.

In some embodiments of this application, the inorganic particles assume a straight through pore structure. An average diameter of the straight through pores is 0.01 μm to 0.2 μm, and preferably 0.1 μm to 0.2 μm. For example, the average diameter of the straight through pores of the inorganic particles is 0.01 μm, 0.02 μm, 0.03 μm, 0.04 μm, 0.05 μm, 0.06 μm, 0.07 μm, 0.08 μm, 0.09 μm, 0.10 μm, 0.11 μm, 0.12 μm, 0.13 μm, 0.14 μm, 0.15 μm, 0.16 μm, 0.17 μm, 0.18 μm, 0.19 μm, 0.20 μm, or a value falling within a range formed by any two thereof. By controlling the average diameter of the straight through pores of the inorganic particles to fall within the above range, this application facilitates transport of the electrolyte solution, and makes the separator more infiltrated by and more absorptive of the electrolyte solution, thereby improving the cycle performance of the battery.

The straight through pore structure means a non-tortuous pore structure that runs through an inorganic particle in a straight line direction.

In some embodiments of this application, an infiltrated length of the separator by the electrolyte solution is 30 mm to 82 mm, and preferably 65 mm to 82 mm. For example, the infiltrated length of the separator by the electrolyte solution is 30 mm, 35 mm, 40 mm, 45 mm, 50 mm, 55 mm, 60 mm, 65 mm, 70 mm, 75 mm, 80 mm, 82 mm, or a value falling within a range formed by any two thereof. By controlling the infiltration length of the separator by the electrolyte solution to fall within the above range, this application makes the separator well infiltrated by the electrolyte solution and improves the capability of the separator in retaining the electrolyte solution, thereby improving the cycle performance of the battery.

In some embodiments of this application, an average diameter of pores in the porous substrate is 0.01 μm to 0.40 μm, and preferably 0.1 μm to 0.4 μm. For example, the average diameter of the pores in the substrate is 0.01 μm, 0.05 μm, 0.10 μm, 0.15 μm, 0.20 μm, 0.25 μm, 0.30 μm, 0.35 μm, 0.40 μm, or a value falling within a range formed by any two thereof. By controlling the average diameter of the pores in the substrate to fall within the above range, this application facilitates transport of the electrolyte solution, and makes the separator more infiltrated by and more absorptive of the electrolyte solution, thereby improving the cycle performance of the battery.

In some embodiments of this application, a porosity of the porous substrate is 40% to 60%, and preferably 48% to 60%. For example, the porosity of the porous substrate may be 40%, 42%, 44%, 46%, 48%, 50%, 52%, 54%, 56%, 58%, 60%, or a value falling within a range formed by any two thereof. By controlling the porosity of the porous substrate to fall within the above range, more electrolyte solution can be adsorbed, and in turn, the cycle performance of the battery is improved.

In some embodiments of this application, a thickness of the porous substrate is 5 μm to 40 μm, and preferably 5 μm to 25 μm. For example, the thickness of the substrate is 5 μm, 10 μm, 15 μm, 20 μm, 25 μm, 30 μm, 35 μm, 40 μm, or a value falling within a range formed by any two thereof. By controlling the thickness of the porous substrate to fall within the above range, this application increases the energy density of the battery, thereby increasing the service life of the electronic device.

In some embodiments of this application, a ratio of the thickness of the inorganic coating layer to the thickness of the porous substrate in the separator is 1:2 to 1:6. For example, the ratio of the thickness of the inorganic coating layer to the thickness of the porous substrate in the separator is 1:2, 1:3, 1:4, 1:5, 1:6, or a value falling within a range formed by any two thereof. By controlling the ratio of the thickness of the inorganic coating layer to the thickness of the porous substrate in the separator to fall within the above range, the coating layer is caused to adhere more strongly to the substrate, and the porous substrate can work more synergistically with the inorganic coating layer, thereby further facilitating transport of the electrolyte solution, improving the infiltration effect of the electrolyte solution for the separator, and in turn, improving the cycle performance of the electrochemical device.

In some embodiments of this application, a particle size D₅₀ of the inorganic particles is 0.30 μm to 1.80 μm, and preferably 0.5 μm to 0.8 μm. For example, the particle size D₅₀ of the inorganic particles is 0.30 μm, 0.40 μm, 0.50 μm, 0.60 μm, 0.70 μm, 0.80 μm, 0.90 μm, 1.00 μm, 1.10 μm, 1.20 μm, 1.30 μm, 1.40 μm, 1.50 μm, 1.60 μm, 1.70 μm, 1.80 μm, or a value falling within a range formed by any two thereof. By controlling the particle size D₅₀ of the inorganic particles in the coating layer of the separator to fall within the above range, this application improves mechanical strength of the separator, and at the same time, makes the separator more resistant to heat shrinkage, thereby improving the cycle performance of the battery.

In this application, the term “D₅₀” is a diameter value at which a cumulative volume percentage of the inorganic particles reaches 50% in a volume-based particle size distribution.

In some embodiments of this application, a mass ratio between the inorganic particles and the polymer is 9:1 to 32:1. For example, the mass ratio between the inorganic particles and the polymer is 9:1, 10:1, 11:1, 12:1, 13:1, 14:1, 15:1, 16:1, 17:1, 18:1, 19:1, 20:1, 21:1, 22:1, 23:1, 24:1, 25:1, 26:1, 27:1, 28:1, 29:1, 30:1, 31:1, 32:1, or a value falling within a range formed by any two thereof. By controlling the mass ratio between the inorganic particles and the polymer to fall within the above range, this application improves the infiltration effect of the electrolyte solution for the separator, thereby improving the cycle performance of the battery. In some embodiments of this application, the inorganic particles include at least one of aluminum oxide, boehmite, or magnesium oxide. By using the above types of inorganic particles, this application enables the preparation of a straight through pore porous structure, improves the mechanical strength of the separator, and at the same time, improves the infiltration effect of the electrolyte solution for the separator, and improves the cycle performance of the battery.

In some embodiments of this application, a swelling degree of the polymer is 10% to 200%. For example, the swelling degree of the polymer may be 10%, 20%, 30%, 40%, 50%, 60%, 70%, 80%, 90%, 100%, 110%, 120%, 130%, 140%, 150%, 160%, 170%, 180%, 190%, 200%, or a value falling within a range formed by any two thereof. By controlling the swelling degree of the polymer to fall within the above range, this application improves the affinity of the electrolyte solution, thereby improving the cycle performance of the battery.

In some embodiments of this application, a particle size D₅₀ of the polymer is 0.15 μm to 0.55 μm. For example, the particle size D₅₀ of the polymer may be 0.15 μm, 0.20 μm, 0.25 μm, 0.30 μm, 0.35 μm, 0.40 μm, 0.45 μm, 0.50 μm, 0.55 μm, or a value falling within a range formed by any two thereof. By controlling the particle size D₅₀ of the polymer to fall within the above range, this application increases the adhesion of the polymer to the inorganic particles and the substrate, thereby improving the cycle performance of the battery. In this application, the term “D₅₀” is a diameter value at which a cumulative volume percentage of the polymer reaches 50% in a volume-based particle size distribution.

In some embodiments of this application, a glass transition temperature of the polymer is −50° C. to 70° C. For example, the glass transition temperature of the polymer may be −50° C., −40° C., −30° C., −20° C., −10° C., 0° C., 10° C., 20° C., 30° C., 40° C., 50° C., 60° C., 70° C., or a value falling within a range formed by any two thereof. By controlling the glass transition temperature of the polymer to fall within the above range, this application increases the adhesion of the polymer to the inorganic particles and the substrate, thereby improving the cycle performance of the battery.

In some embodiments of this application, a specific surface area of the inorganic particles is 15 m²/g to 100 m²/g. For example, the specific surface area of the inorganic particles may be 15 m²/g, 20 m²/g, 25 m²/g, 30 m²/g, 35 m²/g, 40 m²/g, 45 m²/g, 50 m²/g, 55 m²/g, 60 m²/g, 65 m²/g, 70 m²/g, 75 m²/g, 80 m²/g, 85 m²/g, 90 m²/g, 95 m²/g, 100 m²/g, or a value falling within a range formed by any two thereof. By controlling the specific surface area of the inorganic particles to fall within the above range, this application facilitates transport of the electrolyte solution, and improves the infiltration effect of the electrolyte solution for the separator, thereby improving the cycle performance of the battery.

In some embodiments of this application, a porosity of the separator is 30% to 70%. For example, the porosity of the separator may be 30%, 35%, 40%, 45%, 50%, 55%, 60%, 65%, 70%, or a value falling within a range formed by any two thereof. By controlling the porosity of the separator to fall within the above range, this application improves the capability of the separator in retaining the electrolyte solution, and at the same time, reduces a transfer resistance of lithium ions, thereby improving the cycle performance of the battery.

In some embodiments of this application, an air permeability of the separator is 50 s/100 cc to 300 s/100 cc. For example, the air permeability of the separator may be 50 s/100 cc, 100 s/100 cc, 150 s/100 cc, 200 s/100 cc, 250 s/100 cc, 300 s/100 cc, or a value falling within a range formed by any two thereof. By controlling the air permeability of the separator to fall within the above range, this application reduces the ionic resistance of the separator and improves the effect of infiltrating the separator, thereby improving the cycle performance of the battery.

In some embodiments of this application, In some embodiments of this application, a transverse shrinkage of the separator at 130° C. is MD, satisfying: MD≤10%; and the longitudinal shrinkage of the separator at 130° C. is TD, satisfying: TD≤10%. By controlling the transverse and longitudinal shrinkages of the separator to fall within the above ranges, this application improves the safety of the battery, thereby increasing the service life of the electronic device.

The method for preparing the separator is not particularly limited herein, as long as the objectives of this application can be achieved. For example, the separator may be prepared by the following steps:
(1) Preparing a porous substrate by a dry single-step stretching method and/or a wet double-step stretching method. Stretching polyethylene at a low temperature to form micro-defects, and then stretching the defects in all directions uniformly at a high temperature. Controlling the diameter of fibers and the diameter difference between any two fibers to fall within the ranges specified herein by controlling an elongation ratio, so as to ultimately form a porous substrate; and
(2) Mixing the inorganic particles and the polymer in this application evenly at a specified mass ratio to obtain an inorganic coating slurry, in which the straight through pores in the inorganic particles are prepared by a template method; and
(3) Applying the inorganic coating slurry to at least one surface of the substrate, and drying the slurry to obtain a separator.

A second aspect of this application provides an electrochemical device. The electrochemical device includes a positive electrode plate, a negative electrode plate, an electrolyte solution, and the separator disclosed in any one of the embodiments described above. The obtained electrochemical device achieves good cycle performance.

In some embodiments of this application, the negative electrode plate is a silicon-containing negative electrode, in which the mass percent of silicon is 1% to 30%. For example, the mass percent of silicon may be 1%, 5%, 10%, 15%, 20%, 25%, 30%, or a value falling within a range formed by any two thereof. The mass percent of silicon means a percentage of the mass of silicon in the mass of the silicon-containing material. When the mass percent of silicon falls within the range specified herein, the polymer containing at least one of the modifying functional groups —COOH, —NH, or —OH can be grafted onto the surface of the silicon-containing material to effectively reduce the volume expansion of the silicon-containing negative electrode, thereby improving the cycle performance of the electrochemical device.

In this application, the positive electrode plate is not particularly limited, as long as the objectives of this application can be achieved. For example, the positive electrode plate includes a positive current collector and a positive active material layer. The positive current collector is not particularly limited in this application, as long as the objectives of this application can be achieved. For example, the positive current collector may include aluminum foil, aluminum alloy foil, a composite current collector, or the like. The positive active material layer in this application includes a positive active material. The type of the positive active material is not particularly limited in this application, as long as the objectives of this application can be achieved. For example, the positive active material may include at least one of lithium nickel cobalt manganese oxide (NCM811, NCM622, NCM523, NCM111), lithium nickel cobalt aluminum oxide, lithium iron phosphate, a lithium-rich manganese-based material, lithium cobalt oxide (LiCoO₂), lithium manganese oxide, lithium manganese iron phosphate, lithium titanium oxide, or the like. In this application, the positive active material may further include a non-metallic element. For example, the non-metallic elements include at least one of fluorine, phosphorus, boron, chlorine, silicon, or sulfur. Such elements can further improve the stability of the positive active material. In this application, the thicknesses of the positive current collector and the positive active material layer are not particularly limited, as long as the objectives of this application can be achieved. For example, the thickness of the positive current collector is 5 μm to 20 μm, and preferably 6 μm to 18 μm. The thickness of the positive active material layer on a single side is 30 μm to 120 μm. In this application, the positive active material layer may be disposed on one surface of the positive current collector in a thickness direction or on both surfaces of the positive current collector in the thickness direction. Optionally, the positive active material layer may further include a conductive agent and a binder. The types of the conductive agent and the binder in the positive active material are not particularly limited herein, as long as the objectives of this application can be achieved. The mass percentages of the positive active material, conductive agent, or binder in the positive active material layer are not particularly limited herein, and may be selected by a person skilled in the art as actually required, as long as the objectives of this application can be achieved. For example, the mass ratio between the positive active material, the conductive agent, and the binder in the positive active material layer is (97.5 to 97.9):(0.8 to 1.7):(1.0 to 2.0).

The negative current collector is not particularly limited in this application, as long as the objectives of this application can be achieved. For example, the negative current collector may include a copper foil, copper alloy foil, nickel foil, stainless steel foil, titanium foil, foamed nickel, foamed copper, or the like. The negative active material layer in this application includes a negative active material. The negative active material in this application may include at least one of silicon, a silicon-carbon material, SiOₓ (0<x<2), a Li—Sn alloy, Li—Sn—O alloy, Sn, SnO, SnO₂, natural graphite, artificial graphite, mesocarbon microbeads (MCMB), hard carbon, soft carbon, spinel-structured lithium titanium oxide Li₄Ti₅O₁₂, Li—Al alloy, or metallic lithium. The thicknesses of the negative current collector and the negative active material layer are not particularly limited herein, as long as the objectives of this application can be achieved. For example, the thickness of the negative current collector is 6 μm to 10 μm, and the thickness of the negative active material layer is 30 μm to 130 μm. Optionally, the negative active material layer may further include at least one of a conductive agent, a stabilizer, and a binder. The types of the conductive agent, stabilizer, and binder in the negative active material are not particularly limited herein, as long as the objectives of this application can be achieved. The mass percentages of the negative active material, conductive agent, stabilizer, and binder in the negative active material layer are not particularly limited herein, as long as the objectives of this application can be achieved. For example, the mass ratio between the negative active material, conductive agent, stabilizer, and binder in the negative active material layer is (97 to 98):(0.5 to 1.5):(0 to 1.5):(1.0 to 1.9).

In this application, the electrochemical device further includes an electrolyte solution. The electrolyte solution includes a lithium salt and a nonaqueous solvent. The lithium salt may include at least one of LiPF₆, LiBF₄, LiClO₄, LiB(C₆H₅)₄, LiCH₃SO₃, LiCF₃SO₃, LiN(SO₂CF₃)₂, LiC(SO₂CF₃)₃, Li₂SiF₆, lithium bis(oxalato)borate (LiBOB), or lithium difluoroborate. The concentration of the lithium salt in the electrolyte solution is not particularly limited in this application, as long as the objectives of this application can be achieved. For example, the concentration of the lithium salt in the electrolyte solution is 0.9 mol/L to 1.5 mol/L. As an example, the concentration of the lithium salt in the electrolyte solution may be 0.9 mol/L, 1.0 mol/L, 1.1 mol/L, 1.3 mol/L, 1.5 mol/L, or a value falling within a range formed by any two thereof. The nonaqueous solvent is not particularly limited in this application, as long as the objectives of this application can be achieved. For example, the nonaqueous solvent may include, but is not limited to, at least one of a carbonate compound, a carboxylate compound, an ether compound, or other organic solvents. The carbonate compound may include, but is not limited to, at least one of a chain carbonate compound, a cyclic carbonate compound, or a fluorocarbonate compound. The chain carbonate compound may include, but is not limited to, at least one of dimethyl carbonate (DMC), diethyl carbonate (DEC), dipropyl carbonate (DPC), methyl propyl carbonate (MPC), ethylene propyl carbonate (EPC), or ethyl methyl carbonate (EMC). The cyclic carbonate compound may include, but is not limited to, at least one of ethylene carbonate (EC), propylene carbonate (PC), butylene carbonate (BC), or vinyl ethylene carbonate (VEC). The fluorocarbonate compound may include, but is not limited to, at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, or trifluoromethyl ethylene carbonate. The carboxylate compound may include, but is not limited to, at least one of methyl formate, methyl acetate, ethyl acetate, n-propyl acetate, tert-butyl acetate, methyl propionate, ethyl propionate, propyl propionate, y-butyrolactone, decanolactone, valerolactone, or caprolactone. The ether compound may include, but is not limited to, at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The other organic solvent may include, but is not limited to, at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

The electrochemical device in this application is not particularly limited, and may be any device in which an electrochemical reaction occurs. In an embodiment of this application, the electrochemical device may be, but is not limited to, a lithium-ion secondary battery (lithium-ion battery), a lithium polymer secondary battery, a lithium-ion polymer secondary battery, or the like. In an embodiment, structures of the electrode assembly include a jelly-roll structure, a stacked structure, and the like.

The process of preparing the electrochemical device of this application is well known to a person skilled in the art, and is not particularly limited in this application. For example, the preparation process may include, but without being limited to, the following steps: stacking the positive electrode plate, the separator, and the negative electrode plate in sequence, and performing operations such as winding and folding as required to obtain a jelly-roll electrode assembly; putting the electrode assembly into a pocket, injecting the electrolyte solution into the pocket, and sealing the pocket to obtain an electrochemical device; or, stacking the positive electrode plate, the separator, and the negative electrode plate in sequence, and then fixing the four corners of the entire stacked structure by use of adhesive tape to obtain a stacked-type electrode assembly, putting the electrode assembly into the pocket, injecting the electrolyte solution into the pocket, and sealing the pocket to obtain an electrochemical device. In addition, an overcurrent prevention element, a guide plate, and the like may be placed into a pocket as required, so as to prevent the rise of internal pressure, overcharge, and overdischarge of the electrochemical device. The pocket is not particularly limited in this application, and may be selected by a person skilled in the art as actually required, as long as the objectives of this application can be achieved. For example, the pocket may be an aluminum laminated film.

A third aspect of this application provides an electronic device. The electronic device includes the electrochemical device according to any one of the embodiments described above. Therefore, the electronic device exhibits a relatively long service life.

The electronic device is not particularly limited herein, and may be any electronic device known in the prior art. For example, the electronic device may include, but is not limited to, a notebook computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household battery, or lithium-ion capacitor.

### EMBODIMENTS

The implementations of this application are described below in more detail with reference to embodiments and comparative embodiments. Various tests and evaluations are performed by the following methods.

### Test Methods and Devices

### Testing the Ionic Resistance of the Separator:

(1) Preparing a separator: Cutting a separator under test into specimens of 45.3 mm×33.7 mm in equal size. Placing the specimen in a 60° C. environment, keeping baking the specimen for at least 4 hours, and then quickly transferring the specimen into a glovebox ready for use.

(2) Preparing a pocket of a symmetrical battery: Taking a blank symmetrical battery with both a positive current collector and a negative current collector being a copper foil, drying the pocket in a 60° C. environment for at least 4 h before use, and then quickly transferring the pocket into a glovebox for future use;

(3) Assembling a symmetrical battery: In-situ assembling symmetrical batteries as groups of specimens in a glovebox in the form of negative electrode-separator-negative electrode, where each group of specimens includes 5 parallel specimens that contain 1, 2, 3, 4, and 5 layers of separator respectively. Side-sealing the pocket by using a simple sealing machine, injecting the electrolyte solution with a pipette (300 μL), and sealing the bottom of the pocket;

(4) Fixing the symmetrical battery with a jig: Placing the assembled symmetrical battery in the glovebox overnight, so that the electrolyte solution infiltrates the separator thoroughly.

(5) Electrochemical impedance spectroscopy (EIS) test: Placing the symmetrical batteries with different numbers of separator layers in a high- and low-temperature chamber before the EIS measurement, and keeping a constant temperature for half an hour (or, in the case of a low temperature, for a longer period such as two hours). Measuring the EIS at a specified temperature over a frequency range of 1 MHz to 1 kHz at a disturbance voltage of 5 mV. Calculating the ionic resistance of the separator based on the EIS test result.

The composition and preparation method of the positive electrode plate, the negative electrode plate, and the electrolyte solution in the test are the same as those in the corresponding embodiments and comparative embodiments in the table.

### Testing the Infiltration for the Separator:

Cutting a separator into a fixed size (5 mm×100 mm) at a room temperature of 25° C., dripping 1 mL of electrolyte solution in the middle of the separator, leaving the separator to stand for 2 min, and recording a diffusion length of the electrolyte solution as an infiltrated length of the electrolyte solution when the electrolyte solution stops diffusing.

The electrolyte solution for use in the above test is formed from a nonaqueous organic solvent and hexafluorophosphate, and is prepared by the following method: Mixing ethylene carbonate (EC), propylene carbonate (PC), and dimethyl carbonate (DMC) at a mass ratio of 7:2:1 to form a nonaqueous organic solvent, and then adding a lithium salt hexafluorophosphate (LiPF₆) into the nonaqueous organic solvent (the concentration of the LiPF₆ is 1 mol/L), dissolving the lithium salt, and mixing the solution well to obtain an electrolyte solution ready for test.

### Testing the Cycle Performance:

Taking lithium-ion batteries chemically formed in each embodiment and each comparative embodiment for testing, and putting each of the lithium-ion batteries in a 25° C.±2° C. thermostat, and leaving the battery to stand for 2 hours. Charging the battery at a constant current of 0.7 C until the voltage reaches 4.45 V, and then charging the battery at a constant voltage of 4.45 V until the current drops to 0.05 C, and leaving the battery to stand for 15 minutes, and then discharging the battery at a constant current of 0.5 C until the voltage drops to 3.0 V, thereby completing one charge-and-discharge cycle. Recording a discharge capacity of the lithium-ion battery in the first cycle as C₁. Subsequently, repeating the foregoing charge-and-discharge process for 500 cycles, and recording the discharge capacity at the end of the 500^{th} cycle as C₂. Taking 4 lithium-ion batteries for each group, and calculating an average value of a capacity retention rate of the lithium-ion batteries.

Capacity retention rate (%)=C₂ (mAh)/C₁ (mAh)×100%, which represents the cycle performance.

### Embodiment 1-1

### <Preparing a Separator>

Preparing a porous substrate from a polyethylene material (the morphology of the porous substrate is shown in FIG. 2) by the following wet double-step stretching method: Feeding a material, tape-casting the material, stretching the material in a machine direction, and then stretching the material in a transverse direction, and performing extraction and molding; controlling the fiber diameter to fall within a range of 0.01 μm to 0.70 μm by controlling the elongation ratio, and at the same time, controlling the diameter difference between fibers to fall within a range of 0 μm to 0.40 μm; controlling the average diameter of the pores of the porous substrate to be 0.2 μm, and controlling the porosity of the substrate to be 60%, where the inorganic coating layer includes a polymer and inorganic particles, the polymer is conventional styrene-butadiene rubber, and the inorganic particles are conventional boehmite powder; preparing straight through pores by a template method, where an average diameter of the straight through pores is 0.2 μm, and the particle size D₅₀ of the inorganic particles is 0.65 μm; adding the inorganic particles and the polymer into deionized water at a mass ratio of 30:1, and mixing well to obtain a coating slurry in which the solid content is 75 wt %. Applying the coating slurry onto one surface of the substrate, and oven-drying the slurry at 80° C. to obtain a coating layer, thereby making a separator.

### <Preparing a Positive Electrode Plate>

Mixing LiCoO₂ as a positive active material, acetylene black as a conductive agent, and PVDF as a binder at a mass ratio of 97.5:0.8:1.7, adding N-methyl-pyrrolidone (NMP) as a solvent, and stirring the mixture with a vacuum mixer until the system is homogeneous, so as to obtain a positive electrode slurry in which the solid content is 75 wt %. Coating one surface of a 10 μm-thick positive current collector copper foil with the positive electrode slurry evenly, and drying the slurry in a 90° C. environment to obtain a positive electrode plate coated with a 110 μm-thick positive active material layer on a single side. Subsequently, repeating the foregoing steps on the other surface of the aluminum foil to obtain a positive electrode plate coated with the positive active material layer on both sides. Performing oven-drying at 90° C., and then performing cold-pressing, cutting, and tab welding to obtain a positive electrode plate of 74 mm×867 mm in size ready for use.

### <Preparing a Negative Electrode Plate>

Mixing graphite as a negative active material, Super P as a conductive agent, and styrene-butadiene rubber (SBR, with a weight-average molecular weight being approximately 20 W) as a binder at a mass ratio of 97.8:0.7:1.5, and then adding deionized water as a solvent; and mixing the solution with a vacuum mixer to formulate a homogeneous negative electrode slurry in which the solid content is 70 wt %. Applying the negative electrode slurry evenly onto one surface of an 8 μm-thick negative current collector copper foil, and drying the foil at 90° C. to obtain a negative electrode plate coated with a 130 μm-thick negative active material layer on a single side. Subsequently, repeating the foregoing steps on the other surface of the copper foil to obtain a negative electrode plate coated with the negative active material layer on both sides. Performing oven-drying at 90° C., and then performing cold-pressing, cutting, and tab welding to obtain a graphitic negative electrode plate of 76 mm×851 mm in size ready for use.

### <Preparing an Electrolyte Solution>

Mixing ethylene carbonate (EC), diethyl carbonate (DEC), propylene carbonate (PC), propyl propionate (PP), and vinylene carbonate (VC) at a mass ratio of 20:30:20:28:2 in an environment with a moisture content less than 10 ppm, so as to obtain a nonaqueous organic solution. Adding lithium hexafluorophosphate (LiPF₆) into the nonaqueous organic solvent to dissolve, and stirring well to obtain an electrolyte solution, in which the concentration of LiPF₆ is 1 mol/L.

### <Preparing a Lithium-Ion Battery>

Stacking the above-prepared negative electrode plate, separator, and positive electrode plate sequentially, and winding the stacked structure to obtain a jelly-roll electrode assembly. Putting the electrode assembly into an aluminum laminated film pocket, drying the pocket, and then injecting the electrolyte solution. Performing steps such as vacuum sealing, static standing, chemical formation, degassing, and edge trimming to obtain a lithium-ion battery.

### Embodiments 1-2 to 1-25

Identical to Embodiment 1-1 except that, in <Preparing a separator>, the relevant preparation parameters are adjusted according to Table 1.

### Embodiments 2-1 to 2-6

Identical to Embodiment 1-11 except that, in <Preparing a negative electrode plate>, the negative active material graphite is replaced with a silicon-carbon negative electrode material, the mass percent of silicon is a percentage of the mass of silicon in the total mass of the silicon-carbon material, and the relevant preparation parameters are adjusted according to Table 3.

### Comparative Embodiment 1

Identical to Embodiment 1-1 except that, in <Preparing a separator>, the relevant preparation parameters are adjusted according to Table 1.

Table 1, Table 2, and Table 3 show the preparation parameters and performance parameters in each embodiment and each comparative embodiment.

TABLE 1

| | | | | Inorganic particles | | | | | | |
|---|---|---|---|---|---|---|---|---|---|---|
| | | | | Are these | | Average | | | Average | |
| | | | | inorganic | | diameter | | | diameter | |
| | Fiber | | | particles of | | of straight | | | of pores | |
| | | | Diameter | straight | | through | Particle | | of porous | Porosity |
| | | Diameter | difference | through | | pores | size D₅₀ | Polymer | substrate | of |
| | Type | (μm) | (μm) | pores? | Type | (μm) | (μm) | Type | (μm) | substrate |
| Embodiment 1-1 | Polyethylene | 0.01 to | 0 to | Yes | Boehmite | 0.2 | 0.65 | Conventional | 0.2 | 60% |
| | | 0.70 | 0.15 | | | | | SBR | | |
| Embodiment 1-2 | Polyethylene | 0.01 to | 0 to | Yes | Boehmite | 0.2 | 0.65 | Conventional | 0.2 | 60% |
| | | 0.4 | 0.15 | | | | | SBR | | |
| Embodiment 1-3 | Polyethylene | 0.01 to | 0 to | Yes | Boehmite | 0.2 | 0.65 | Conventional | 0.2 | 60% |
| | | 0.70 | 0.40 | | | | | SBR | | |
| Embodiment 1-4 | Polyethylene | 0.01 to | 0 to | Yes | Boehmite | 0.2 | 0.65 | Conventional | 0.2 | 60% |
| | | 0.70 | 0.25 | | | | | SBR | | |
| Embodiment 1-5 | Polyethylene | 0.01 to | 0 to | Yes | Boehmite | 0.2 | 0.65 | Conventional | 0.2 | 60% |
| | | 0.25 | 0.15 | | | | | SBR | | |
| Embodiment 1-6 | Polyethylene | 0.01 to | 0 to | Yes | Boehmite | 0.01 | 0.65 | Conventional | 0.2 | 60% |
| | | 0.25 | 0.15 | | | | | SBR | | |
| Embodiment 1-7 | Polyethylene | 0.01 to | 0 to | Yes | Boehmite | 0.1 | 0.65 | Conventional | 0.2 | 60% |
| | | 0.25 | 0.15 | | | | | SBR | | |
| Embodiment 1-8 | Polyethylene | 0.01 to | 0 to | Yes | Boehmite | 0.2 | 0.65 | Modified SBR | 0.2 | 60% |
| | | 0.25 | 0.15 | | | | | (grafted | | |
| | | | | | | | | with —COOH) | | |
| Embodiment 1-9 | Polypropylene | 0.01 to | 0 to | Yes | Boehmite | 0.2 | 0.65 | Modified SBR | 0.2 | 60% |
| | | 0.25 | 0.15 | | | | | (grafted | | |
| | | | | | | | | with —OH) | | |
| Embodiment 1-10 | Polyethylene | 0.01 to | 0 to | Yes | Boehmite | 0.2 | 0.65 | Modified SBR | 0.2 | 60% |
| | | 0.25 | 0.15 | | | | | (grafted | | |
| | | | | | | | | with —NH) | | |
| Embodiment 1-11 | Polyethylene | 0.01 to | 0 to | Yes | Boehmite | 0.2 | 0.65 | Modified SBR | 0.4 | 60% |
| | | 0.25 | 0.15 | | | | | (grafted | | |
| | | | | | | | | with —COOH) | | |
| Embodiment 1-12 | Polyethylene | 0.01 to | 0 to | Yes | Boehmite | 0.2 | 0.65 | Conventional | 0.4 | 40% |
| | | 0.25 | 0.15 | | | | | SBR | | |
| Embodiment 1-13 | Polyethylene | 0.01 to | 0 to | Yes | Boehmite | 0.2 | 0.65 | Conventional | 0.4 | 48% |
| | | 0.25 | 0.15 | | | | | SBR | | |
| Embodiment 1-14 | Polyethylene | 0.01 to | 0 to | Yes | Boehmite | 0.2 | 0.65 | Conventional | 0.01 | 60% |
| | | 0.25 | 0.15 | | | | | SBR | | |
| Embodiment 1-15 | Polyethylene | 0.01 to | 0 to | Yes | Boehmite | 0.2 | 0.65 | Conventional | 0.4 | 60% |
| | | 0.25 | 0.15 | | | | | SBR | | |
| Embodiment 1-16 | Polyethylene | 0.01 to | 0 to | Yes | Boehmite | 0.2 | 0.65 | Conventional | 0.1 | 60% |
| | | 0.25 | 0.15 | | | | | SBR | | |
| Embodiment 1-17 | Polyethylene | 0.01 to | 0 to | Yes | Aluminum | 0.2 | 0.65 | Conventional | 0.4 | 60% |
| | | 0.25 | 0.15 | | oxide | | | SBR | | |
| Embodiment 1-18 | Polyethylene | 0.01 to | 0 to | None | Boehmite | / | 0.65 | Conventional | 0.2 | 60% |
| | | 0.25 | 0.15 | | | | | SBR | | |
| Embodiment 1-19 | Polyethylene | 0.01 to | 0 to | Yes | Boehmite | 0.005 | 0.65 | Conventional | 0.2 | 60% |
| | | 0.25 | 0.15 | | | | | SBR | | |
| Embodiment 1-20 | Polyethylene | 0.01 to | 0 to | Yes | Boehmite | 0.2 | 0.65 | Conventional | 0.2 | 30% |
| | | 0.25 | 0.15 | | | | | SBR | | |
| Embodiment 1-21 | Polyethylene | 0.01 to | 0 to | Yes | Boehmite | 0.2 | 0.65 | Conventional | 0.2 | 60% |
| | | 0.5 | 0.25 | | | | | SBR | | |
| Embodiment 1-22 | Polyethylene | 0.01 to | 0 to | Yes | Boehmite | 0.2 | 0.65 | Conventional | 0.2 | 60% |
| | | 0.4 | 0.30 | | | | | SBR | | |
| Embodiment 1-23 | Polyethylene | 0.01 to | 0 to | Yes | Boehmite | 0.2 | 0.65 | Conventional | 0.2 | 60% |
| | | 0.3 | 0.15 | | | | | SBR | | |
| Embodiment 1-24 | Polyethylene | 0.01 to | 0 to | Yes | Boehmite | 0.2 | 0.65 | Styrene | 0.2 | 60% |
| | | 0.25 | 0.15 | | | | | propylene | | |
| | | | | | | | | polymer | | |
| Embodiment 1-25 | Polyethylene | 0.01 to | 0 to | Yes | Boehmite | 0.2 | 0.65 | Modified SBR | 0.2 | 60% |
| | | 0.25 | 0.15 | | | | | (grafted | | |
| | | | | | | | | with —CO₂CH₃) | | |
| Comparative | Polyethylene | 0.01 to | 0 to | Yes | Boehmite | 0.2 | 0.65 | Conventional | 0.2 | 60% |
| Embodiment 1 | | 0.80 | 0.50 | | | | | SBR | | |

Note:
“/” in Table 1 represents absence of the relevant preparation parameter.

TABLE 2

| | | | Cycle capacity |
|---|---|---|---|
| | Ionic | Infiltrated | retention rate |
| | resistance of | length of | of battery cycled |
| | separator (Ω) | separator (mm) | for 500 cycles |
| Embodiment 1-1 | 0.78 | 32 | 66% |
| Embodiment 1-2 | 0.73 | 34 | 68% |
| Embodiment 1-3 | 0.83 | 30 | 63% |
| Embodiment 1-4 | 0.81 | 31.5 | 65% |
| Embodiment 1-5 | 0.66 | 37 | 72.5% |
| Embodiment 1-6 | 0.70 | 34 | 68% |
| Embodiment 1-7 | 0.69 | 35 | 70% |
| Embodiment 1-8 | 0.50 | 80 | 85% |
| Embodiment 1-9 | 0.52 | 75 | 83% |
| Embodiment 1-10 | 0.54 | 65 | 81% |
| Embodiment 1-11 | 0.48 | 82 | 87% |
| Embodiment 1-12 | 0.65 | 37.5 | 73.5% |
| Embodiment 1-13 | 0.63 | 38 | 74% |
| Embodiment 1-14 | 0.70 | 34 | 68% |
| Embodiment 1-15 | 0.61 | 40 | 76% |
| Embodiment 1-16 | 0.69 | 35 | 68.5% |
| Embodiment 1-17 | 0.65 | 37.6 | 74% |
| Embodiment 1-18 | 0.70 | 34 | 68% |
| Embodiment 1-19 | 0.69 | 34.5 | 69% |
| Embodiment 1-20 | 0.68 | 35 | 68.5% |
| Embodiment 1-21 | 0.74 | 32.5 | 67% |
| Embodiment 1-22 | 0.82 | 31.3 | 64% |
| Embodiment 1-23 | 0.70 | 34 | 68% |
| Embodiment 1-24 | 0.85 | 28 | 61% |
| Embodiment 1-25 | 0.59 | 59 | 70% |
| Comparative | 0.90 | 25 | 55% |
| Embodiment 1 | | | |

TABLE 3

| | | | Cycle capacity |
|---|---|---|---|
| | | Mass | retention rate |
| | | percent of | of battery cycled |
| | Type of polymer | silicon | for 500 cycles |
| Embodiment 1-11 | Modified SBR (grafted with | 0% | 87% |
| | —COOH) | | |
| Embodiment 2-1 | Modified SBR (grafted with | 1% | 90% |
| | —COOH) | | |
| Embodiment 2-2 | Modified SBR (grafted with | 15% | 94% |
| | —COOH) | | |
| Embodiment 2-3 | Modified SBR (grafted with | 30% | 91% |
| | —COOH) | | |
| Embodiment 2-4 | Modified SBR (grafted with | 40% | 85% |
| | —COOH) | | |
| Embodiment 2-5 | Modified SBR (grafted with | 15% | 91% |
| | —OH) | | |
| Embodiment 2-6 | Modified SBR (grafted with | 15% | 89% |
| | —NH) | | |

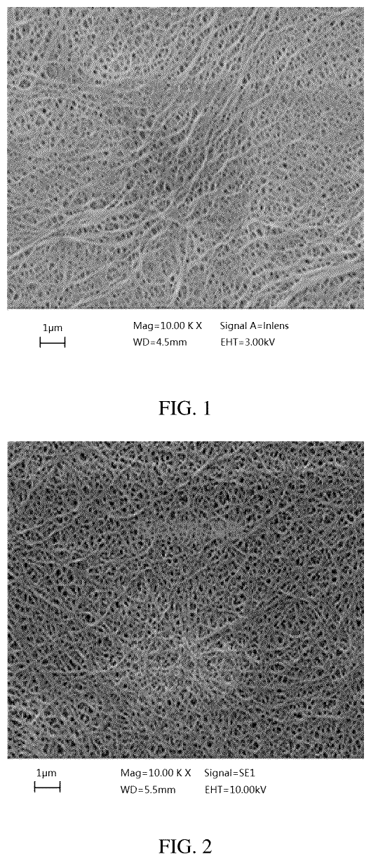

As can be seen from Embodiments 1-1 to 1-25 versus Comparative Embodiment 1, the porous substrate is used together with the inorganic coating layer disposed on at least one surface of the porous substrate. The diameter of the fibers in the porous substrate and the diameter difference between any two fibers are controlled to fall within the ranges specified herein. The structures of the polymer and the inorganic particles in the inorganic coating layer are required to meet the specified conditions so that the porous substrate and the inorganic coating layer work synergistically, thereby reducing the ionic resistance of the separator, increasing the mechanical strength of the separator, and at the same time, increasing the infiltrated length of the separator, improving the infiltration for the separator, and in turn, improving the cycle capacity retention rate of the lithium-ion battery, and improving the cycle performance of the lithium-ion battery. As can be seen from FIG. 1 and FIG. 2, the porous substrate in this application is denser and more uniformly distributed than the conventional substrate, thereby improving the infiltration for the separator, and improving the cycle performance of the lithium-ion battery.

As can be seen from Embodiments 1-1 to 1-5, Embodiments 1-21 to 1-23 versus Comparative Embodiment 1, the fiber diameter of the porous substrate and the diameter difference between any two fibers are controlled to fall within the ranges specified herein, thereby reducing the ionic resistance of the separator, and at the same time, increasing the infiltrated length of the separator, improving the infiltration for the separator, further facilitating transport of lithium ions, and improving the cycle capacity retention rate of the lithium-ion battery.

As can be seen from Embodiments 1-5 and 1-18, when the inorganic particles in the separator contain a straight through pore structure, the mechanical strength of the separator is improved, and at the same time, the infiltrated length of the separator is increased. The infiltration for the separator is improved, and the transport of lithium ions is facilitated, thereby improving the cycle performance of the lithium-ion battery.

As can be seen from Embodiments 1-5 to 1-7 and Embodiment 1-19, when the inorganic particles in the separator contain a straight through pore structure, and when the average diameter of the straight through pores falls within the range specified herein, the mechanical strength of the separator is improved, and at the same time, the infiltrated length of the separator is increased. The infiltration for the separator is improved, and the transport of lithium ions is facilitated, thereby improving the cycle performance of the lithium-ion battery.

As can be seen from Embodiments 1-8 to 1-10, Embodiment 1-24, 1-25, and 1-5, by grafting the polymer styrene-butadiene rubber in the separator with the three types of modifying functional groups that satisfy the range specified herein, this application can further reduce the ionic resistance of the separator and significantly increase the infiltrated length of the separator, thereby increasing the cycle capacity retention rate of the lithium-ion battery and improving the cycle performance of the lithium-ion battery.

As can be seen from Embodiment 1-5, Embodiments 1-12 to 1-16, and Embodiment 1-20, by controlling the average diameter of the pores in the substrate and the porosity to fall within the ranges specified herein, this application further facilitates transport of the electrolyte solution, and makes the separator more infiltrated by and more absorptive of the electrolyte solution, thereby improving the cycle performance of the battery.

As can be seen from Embodiments 2-1 to 2-6 versus Embodiment 1-11, when the separator containing a polymer is adapted to a silicon-containing negative electrode, if the polymer contains at least one of the modifying functional groups —OH, —COOH, or —NH and the mass percent of silicon in the selected silicon-containing negative electrode satisfies the range of this application, the cycle performance of the battery is improved by reducing the expansion of the silicon-containing negative electrode.

As can be clearly understood from the embodiments versus comparative embodiments, the porous substrate of this application can effectively reduce the ionic resistance of the separator, thereby improving the transport of lithium ions. The inorganic coating layer falling within the range specified herein can increase the infiltrated length of the separator and improve the infiltration effect of the electrolyte solution for the separator, thereby improving the cycle performance of the lithium-ion battery and increasing the cycle life of the lithium-ion battery. It is hereby noted that, as used herein, the terms “include”, “comprise”, and any variations thereof are intended to cover a non-exclusive inclusion relationship, whereby a process, method, item, or device that includes a series of elements not only includes such elements, but also includes other elements not expressly specified or also includes inherent elements of the process, method, item, or device.

Different embodiments of this application are described in a correlative manner. For the same or similar part in one embodiment, reference may be made to another embodiment. Each embodiment focuses on differences from other embodiments.

What is described above is merely preferred embodiments of this application, but not intended to limit the protection scope of this application. Any modifications, equivalent replacements, improvements, and the like made without departing from the spirit and principles of this application still fall within the protection scope of this application.

What is claimed is:

1. A separator, comprising a porous substrate and an inorganic coating layer disposed on at least one surface of the porous substrate; wherein
the porous substrate comprises fibers, wherein the fibers are made of a material comprising at least one of polyethylene or polypropylene, a diameter of the fibers is 0.01 μm to 0.70 μm, and a diameter difference between any two fibers ranges from 0 μm to 0.40 μm; and
the inorganic coating layer comprises a polymer and inorganic particles; wherein the polymer comprises at least one of styrene-butadiene rubber, a polyacrylate ester, a polyolefin, or a modifying functional group, and the modifying functional group comprises at least one of —OH, —COOH, or —NH.

2. The separator according to claim 1, wherein the inorganic particles contain straight through pores, and an average diameter of the straight through pores is 0.01 μm to 0.2 μm.

3. The separator according to claim 1, wherein an infiltrated length of the separator by the electrolyte solution is 30 mm to 82 mm.

4. The separator according to claim 1, wherein in the porous substrate, the diameter of the fibers is 0.01 μm to 0.40 μm, and the diameter difference between any two fibers ranges from 0 μm to 0.25 μm.

5. The separator according to claim 2, wherein an average diameter of the straight through pores is 0.1 μm to 0.2 μm.

6. The separator according to claim 1, wherein an infiltrated length of the separator by the electrolyte solution is 65 mm to 82 mm.

7. The separator according to claim 1, wherein an average diameter of pores in the porous substrate is 0.01 μm to 0.40 μm.

8. The separator according to claim 1, wherein an average diameter of pores in the porous substrate is 0.1 μm to 0.40 μm.

9. The separator according to claim 1, wherein a porosity of the porous substrate is 40% to 60%.

10. The separator according to claim 1, wherein a porosity of the porous substrate is 48% to 60%.

11. An electrochemical device, comprising a positive electrode plate, a negative electrode plate, a separator, and an electrolyte solution, wherein the separator is located between the positive electrode plate and the negative electrode plate, and the separator comprises a porous substrate and an inorganic coating layer disposed on at least one surface of the porous substrate, wherein
the porous substrate comprises fibers, wherein the fibers are made of a material comprising at least one of polyethylene or polypropylene, a diameter of the fibers is 0.01 μm to 0.70 μm, and a diameter difference between any two fibers ranges from 0 μm to 0.40 μm; and
the inorganic coating layer comprises a polymer and inorganic particles; wherein the polymer comprises at least one of styrene-butadiene rubber, a polyacrylate ester, a polyolefin, or a modifying functional group, and the modifying functional group comprises at least one of —OH, —COOH, or —NH.

12. The electrochemical device according to claim 11, wherein the inorganic particles contain straight through pores, and an average diameter of the straight through pores is 0.01 μm to 0.2 μm.

13. The electrochemical device according to claim 11, wherein an infiltrated length of the separator by the electrolyte solution is 30 mm to 82 mm.

14. The electrochemical device according to claim 11, wherein in the porous substrate, the diameter of the fibers is 0.01 μm to 0.40 μm, and the diameter difference between any two fibers ranges from 0 μm to 0.25 μm.

15. The electrochemical device according to claim 14, wherein an average diameter of the straight through pores is 0.1 μm to 0.2 μm.

16. The electrochemical device according to claim 11, wherein an infiltrated length of the separator by the electrolyte solution is 65 mm to 82 mm.

17. The electrochemical device according to claim 11, wherein an average diameter of pores in the porous substrate is 0.01 μm to 0.40 μm.

18. The electrochemical device according to claim 11, wherein an average diameter of pores in the porous substrate is 0.1 μm to 0.40 μm.

19. The electrochemical device according to claim 11, wherein a porosity of the porous substrate is 40% to 60%.

20. An electronic device, comprising an electrochemical device, wherein the electrochemical device comprises a positive electrode plate, a negative electrode plate, a separator, and an electrolyte solution, wherein the separator is located between the positive electrode plate and the negative electrode plate, and the separator comprises a porous substrate and an inorganic coating layer disposed on at least one surface of the porous substrate, wherein
the porous substrate comprises fibers, wherein the fibers are made of a material comprising at least one of polyethylene or polypropylene, a diameter of the fibers is 0.01 μm to 0.70 μm, and a diameter difference between any two fibers ranges from 0 μm to 0.40 μm; and
the inorganic coating layer comprises a polymer and inorganic particles, wherein the polymer comprises at least one of styrene-butadiene rubber, a polyacrylate ester, or a polyolefin, or the polymer comprises a modifying functional group, and the modifying functional group comprises at least one of —OH, —COOH, or —NH.
